(19) United States
(12) Patent Application Publication
(10) Pub. No.: US 2004/0052964 A1
(43) Pub. Date: Mar. 18, 2004

(54) Method for coating the inside of a gun barrel

(75) Inventor: Stefan Kaufmann, Celle (DE)

Correspondence Address: VENABLE, BAETJER, HOWARD AND CIVILETTI, LLP, P.O. BOX 34385, WASHINGTON, DC, 20043-9998, US

(73) Assignee: Rheinmetall W & M GmbH, Unterluss (DE)

(21) Appl. No.: 10/647,535

(22) Filed: Aug. 26, 2003

(30) Foreign Application Priority Data
Sep. 18, 2002 (DE) DE 102 43 314.3
Jun. 17, 2003 (DE) DE 103 29 131.8

(51) Int. Cl. B05D 7/22; B05D 1/08

(52) U.S. Cl. 427/446; 427/230; 427/595

(57) ABSTRACT

A method for coating the inside surface (5) of a gun barrel (1), at least in a partial region (2), with a layer of a layer material (9) for avoiding erosion. For the simple application of layer materials that melt at high temperatures to the inside surface (5) of the gun barrel (1), with the internal-stress state of the barrel (1) only being influenced to a small extent by the heat input, the coating is applied to the inside surface of the respective barrel (1) through plasma spraying, and simultaneously directing a laser beam (7) toward the inside surface (5) of the barrel (1), to melt the near-surface gun-barrel region (10) that is already coated or is to be coated. This causes the formation of a molten bath (11) that contains the melted gun-barrel material and the layer material in the near-surface region (10) of the barrel, with the bath hardening as the laser beam (7) continues to move.

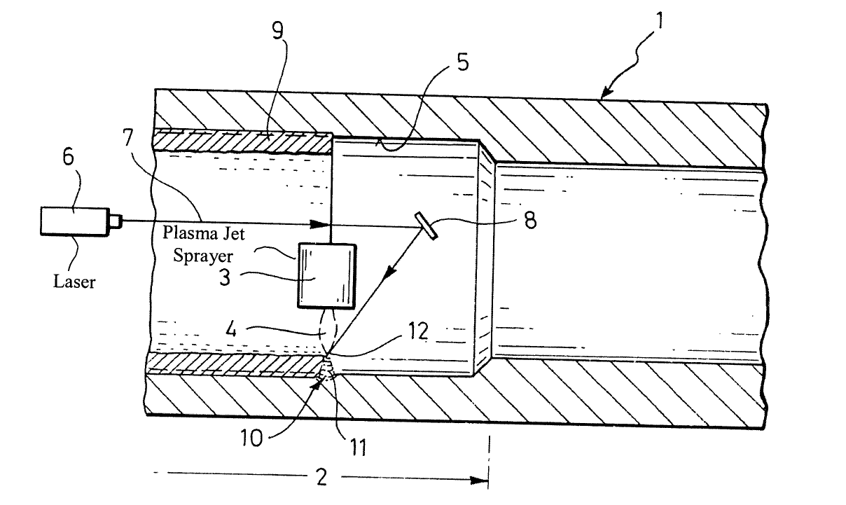

### CROSS REFERENCE TO RELATED APPLICATION

This application claims the priority of German Patent Applications, DE 102 43314.3 filed Sep. 18, 2002 and DE 103 29 131.8 filed Jun. 27, 2003 which are incorporated herein by reference.

### BACKGROUND OF THE INVENTION

The invention relates to a method for coating the inside of a gun barrel, whose inside surface is provided, at least in a partial region, with a layer comprising a layer or coating material in order to avoid erosion.

In weapons technology, types of ammunition having improved performance cause severe erosion, especially in steel gun barrels, because of the high gas temperatures and high flow speeds that occur upon firing. This erosion causes the barrel to wear before it has reached its fatigue service life. It is already known to provide the corresponding barrels with a layer of hard chromium to avoid such erosion. In this case, the hard chromium is applied to the inside barrel surface through electrolytic deposition.

One of the drawbacks of this known method is that the electrolytically deposited hard-chromium layers cannot withstand the increased-performance ammunition. Severe erosion gradually occurs at rupture points in the chromium layer.

It has been proposed to employ methods such as plasma spraying or laser-deposition welding to provide the inside surface of the barrel with protective layers that are up to a few mm thick and comprise materials that have a high melting point, such as niobium, molybdenum, tantalum, hafnium, vanadium, tungsten, zirconium or their alloys. It has been seen that, when plasma spraying is used on the inside barrel surface, the protective layers deposited exhibit a relatively poor adhesion to the base material of the barrel and a high porosity.

In the process of laser-application welding, a laser beam is aimed at the inside surface of the gun barrel, and melts the regions of the barrel that are located near the surface. The layer or coating material is introduced, in powdered, wire or strip form, shortly before the laser beam impacts the inside barrel surface, and is melted by the beam, so a molten bath containing the melted barrel material and the layer material is formed in the region near the barrel surface. The molten bath hardens as the laser beam continues to move along the barrel.

A disadvantage of laser-application welding is that a relatively large amount of heat must be introduced into the barrel material, which causes the formation of heat-affected zones of a depth up to 10 mm. This has a negative influence on the autofrettage internal stresses of the corresponding barrel.

### SUMMARY OF THE INVENTION

It is the object of the invention to provide a method for coating the inside of a gun barrel, with which layer materials that melt at high temperatures can be applied to the inside barrel surface to avoid erosion, with the materials binding well with the base material of the barrel. Moreover, the internal-stress state of the barrel should only be influenced to a small extent by the heat input when the materials are applied.

In accordance with the invention, the above object generally is achieved by an underlying concept of applying a protective layer to the inside surface of the gun barrel using a laser-supported plasma-spraying method. In the process, the layer material is applied to the inside barrel surface through plasma spraying. A laser beam is simultaneously aimed at the inside surface of the barrel, and the near-surface regions of the barrel that are coated or are to be coated melt, so a molten bath containing the melted barrel material and the layer material is formed in the region near the barrel surface. The molten bath hardens as the laser beam continues to move.

Surprisingly, with a method of this type, it has been found that the protective layer and the base material of the gun barrel (usually steel) form a reliable bond, on the one hand, and no large quantities of energy are introduced into the base material, on the other hand, so that an internal-stress state caused in the barrel by the autofrettage process is only influenced slightly or to a negligible extent. This occurs because the heat input is such that the heating depth is in a range of ≦5 mm, preferably in a range of ≦1 mm.

Further details about and advantages of the invention ensue from the exemplary embodiment described below in conjunction with a drawing FIGURE.

### BRIEF DESCRIPTION OF THE DRAWINGS

The FIGURE is a partial longitudinal sectional view of a gun barrel schematically illustrating the apparatus for carrying out the method according to the invention.

### DETAILED DESCRIPTION OF THE INVENTION

The FIGURE illustrates a gun barrel 1, which is to be coated in a partial region 2 with a hard metal, e.g. niobium

For coating the barrel 1, a known plasma-spraying system 3 is disposed in the barrel. The system 3 generates a high-temperature, high-speed plasma jet 4, into which the powdered coating or layer material is introduced in a known manner via a powder injector, not shown. The hot plasma jet 4 melts the coating or layer material, which is then accelerated at high speed and in droplet form toward the inside surface 5 of the gun barrel 1.

At the same time, a deflecting mirror 8 diverts the laser beam 7 emitted by a laser 6, e.g., a CO₂ or Nd:YAG laser, toward the inside surface 5 of the gun barrel 1, and the barrel region 10 being coated with the layer material 9 via the plasma jet 4 is briefly melted, so a molten bath 11 containing the melted barrel material and the layer material 9 is formed in the region near the surface of the barrel 1. The energy of the laser 6 is such that the depth of the melting is equal to or less than 5 mm, and preferably equal to or less than 1 mm. The molten bath hardens as the plasma jet 4 and the laser beam 7 continue to move along the gun barrel 1.

The plasma-spraying system 3, and the laser beam 2 and the execute a helical movement relative to the gun barrel 1, which effects a large-surface coating of the inside surface 5 of the barrel 1. For this purpose, the deflecting mirror 8 can execute both an axial and a rotational movement with the plasma-spraying system 3, for example, with the aid of a travel device, not shown.

If necessary, a mechanical aftertreatment can follow the application of the layer material 9 to the partial region 2.

Of course, the invention is not limited to the above-described exemplary embodiment. For example, the laser beam 7 need not be aimed directly at the focal point 12 of the plasma jet 4, but can briefly melt the inside surface of the barrel 1 directly in front of the focal point 12.

To improve the adhesion, it may also be advantageous to apply a plurality of layers of identical or different layer materials successively to the inside surface of the gun barrel, instead of only one layer of layer material.

The invention now being fully described, it will be apparent to one of ordinary skill in the art that many changes and modifications can be made thereto without departing from the spirit or scope of the invention as set forth herein.

What is claimed is:

1. A method for coating the inside of a gun barrel, whose inside surface is to be provided, at least in a partial region, with a layer of a high melting temperature coating or layer material for reducing erosion of the gun barrel, said method comprising:
providing a plasma jet spray device and moving the device along the interior of the gun barrel;
applying the layer material to an inside surface of a gun barrel through use of the plasma jet spraying device;
simultaneously with the plasma spraying, directing a laser beam toward the inside surface of the barrel to produce a molten bath containing melted gun-barrel material and the layer material in a near-surface region of the barrel that is being coated; and,
thereafter permitting the bath to harden.

2. The method according to claim 1, wherein the step of directing includes directing the laser beam toward the inside surface of the gun barrel at a focal point of the plasma jet.

3. The method according to claim 1, wherein the step of directing includes directing the laser beam toward the inside surface of the gun barrel directly in front of the plasma jet in the direction of movement.

4. The method according to claim 1, wherein the moving takes place at least in an axial direction of the gun barrel.

5. The method according to claim 1, wherein the moving of the plasma jet and of the laser beam follows a helical path relative to the gun barrel.

6. The method according to claim 1, wherein the depth of heat of the inside surface of the gun barrel is equal to or less than 5 mm.

7. The method according to claim 1, wherein the depth of heat of the inside surface of the gun barrel is equal to or less than 1 mm.

8. The method according to claim 1, wherein hardening is carried due to movement of the laser away from a region of the molten bath.

9. The method according to claim 8, wherein the movement of the laser beam is continuous.
